(19) United States
(12) Patent Application Publication
(10) Pub. No.: US 2016/0210069 A1
(43) Pub. Date: Jul. 21, 2016

(54) Systems and Methods For Overriding Memory Access Permissions In A Virtual Machine

(71) Applicant: Bitdefender IPR Management Ltd., Nicosia (CY)

(72) Inventors: Andrei V. LUTAS, Satu Mare (RO); Sandor LUKACS, Floresti (RO)

(21) Appl. No.: 14/601,475

(22) Filed: Jan. 21, 2015

(51) Int. Cl. G06F 3/06; G06F 12/10

(52) U.S. Cl. CPC G06F 3/0622; G06F 3/0637; G06F 3/0664; G06F 3/0673; G06F 12/10; G06F 2212/65

(57) ABSTRACT

Described systems and methods allow an instruction that violates memory access permissions within a virtual machine to execute natively (i.e., within the respective virtual machine), when such execution is deemed acceptable by security software executing at the level of the hypervisor. In some embodiments, the processor is endowed with a register having a set of control fields (e.g., control bits) that regulate permission overrides. Control fields may be accessible to software via a VM state object such as the VMCS on Intel® platforms.

### BACKGROUND

The invention relates to systems and methods for performing memory management in computer systems, and in particular, to systems and methods for accessing guest memory in hardware virtualization environments.

Computer systems typically use a physical memory (e.g., a semiconductor chip) to hold data manipulated by the processor during computation. Such data includes, for instance, representations of processor instructions, inputs, and outputs of computation. Physical memory is accessed using an addressing system, wherein each addressable memory location has a unique physical address.

Modern software usually operates with an abstraction of physical memory, known as virtual memory. A virtual memory space is typically allocated to each application executing on the respective computer system. Virtual memory is addressable via a set of virtual addresses, also known as logical addresses. Each such virtual address is mapped, for instance by an operating system of the respective computer system, to a physical address within the physical memory. A hardware component, typically known as a memory management unit (MMU), may perform the actual virtual-to-physical address translations, using specialized devices and mechanisms such as translation lookaside buffers (TLB) and/or page tables. Some hardware platforms allow setting access permissions for selected regions of physical memory, such permissions specifying a manner in which each memory region may be accessed (e.g., write, read, execute).

Hardware virtualization technology allows the creation of simulated computer environments commonly known as virtual machines (VM), which behave in many ways as physical computer systems. In many applications, such as server consolidation and infrastructure-as-a-service, several virtual machines may run simultaneously on the same computer system, sharing hardware resources among them, thus reducing investment and operating costs. Each virtual machine may run its own operating system and/or software applications, separately from other virtual machines.

Malicious software, also known as malware, affects a great number of computer systems worldwide. In its many forms such as computer viruses, worms, rootkits, and spyware, malware presents a serious risk to millions of computer users, making them vulnerable to loss of data and sensitive information, identity theft, and loss of productivity, among others. Computer security software may be used to protect a computer system from malware.

The operation of computer security software is substantially more complex and computationally expensive when carried out in hardware virtualization environments, compared to non-virtualized environments. The extra complexity is particularly clear when the computer security software executes outside the protected VM. One reason for the extra computational cost is that in hardware virtualization configurations every memory access typically requires an additional level of address translations: a translation from the virtualized physical memory of the respective VM to the actual physical memory of the computer system. Another source of complexity is that a violation of a memory access permission detected within a virtual machine typically causes a suspension of execution of the respective virtual machine. The respective event may be processed by virtualization management software (e.g., a hypervisor), before resuming execution of the respective virtual machine. Such virtual machine suspend/resume cycles may carry a substantial computational expense.

There is a substantial interest in improving the efficiency of computer security operations in hardware virtualization platforms.

### SUMMARY

According to one aspect, a host system comprises a hardware processor configured to execute a virtual machine and a computer security program, wherein the hardware processor comprises a register including an override field, and wherein the computer security program is configured to modify a content of the override field. The hardware processor is further configured to determine whether accessing a memory location causes a violation of an access permission, wherein accessing the memory location occurs as part of executing an instruction within the virtual machine. In response, when accessing the memory location causes the violation, the hardware processor is further configured to determine according to the content of the override field whether permission override is enabled, and in response, when permission override is enabled, to access the memory location.

According to another aspect, a method protects a host system from computer security threats, the host system comprising a hardware processor, the hardware processor further comprising a register that includes an override field. The method comprises employing a computer security program to modify a content of the override field. The method further comprises employing the hardware processor to determine whether accessing a memory location causes a violation of an access permission, wherein accessing the memory location occurs as part of executing an instruction within a virtual machine exposed on the host system. The method further comprises in response, when accessing the memory location causes the violation, employing the hardware processor to determine according to the content of the override field whether permission override is enabled, and in response, when permission override is enabled, employing the hardware processor to access the memory location.

According to another aspect, a non-transitory computer-readable medium stores instructions which, when executed by a hardware processor of a host system exposing a virtual machine, cause the host system to form a computer security program. The hardware processor comprises a register that includes an override field. The computer security program is configured to modify a content of the override field. The hardware processor is further configured to determine whether accessing a memory location causes a violation of an access permission, wherein accessing the memory location occurs as part of executing a guest instruction within the virtual machine. The hardware processor is further configured in response, when accessing the memory location causes the violation, to determine according to a the content of the override field whether permission override is enabled, and in response, when permission override is enabled, to access the memory location.

### BRIEF DESCRIPTION OF THE DRAWINGS

The foregoing aspects and advantages of the present invention will become better understood upon reading the following detailed description and upon reference to the drawings where:

FIG. 1 shows an exemplary hardware configuration of a host computer system protected from computer security threats according to some embodiments of the present invention.

FIG. 2 shows an exemplary set of virtual machines exposed by a hypervisor executing on the host system, and a computer security module protecting the set of virtual machines from computer security threats according to some embodiments of the present invention.

FIG. 3 shows an exemplary configuration of virtualized hardware exposed as a guest virtual machine according to some embodiments of the present invention.

FIG. 4 shows a set of exemplary memory address translations in a hardware virtualization configuration as shown in FIG. 2, according to some embodiments of the present invention.

FIG. 5 shows exemplary components of a processor and of a memory management unit (MMU) according to some embodiments of the present invention.

FIG. 6 shows an exemplary set of fields of an override register of the processor, according to some embodiments of the present invention.

FIG. 7 illustrates the components and operation of an exemplary permission override module, according to some embodiments of the present invention.

FIG. 8 shows an exemplary interconnection of hardware components of the processor and/or the MMU, enabling some embodiments of the present invention to override memory access permissions.

FIG. 9 shows an exemplary sequence of steps performed by a computer security program to configure an override of memory access permissions according to some embodiments of the present invention.

FIG. 10 illustrates an exemplary sequence of steps performed by the processor and/or by the MMU to override memory access permissions according to some embodiments of the present invention.

### DETAILED DESCRIPTION OF PREFERRED EMBODIMENTS

In the following description, it is understood that all recited connections between structures can be direct operative connections or indirect operative connections through intermediary structures. A set of elements includes one or more elements. Any recitation of an element is understood to refer to at least one element. A plurality of elements includes at least two elements. Unless otherwise required, any described method steps need not be necessarily performed in a particular illustrated order. A first element (e.g. data) derived from a second element encompasses a first element equal to the second element, as well as a first element generated by processing the second element and optionally other data. Making a determination or decision according to a parameter encompasses making the determination or decision according to the parameter and optionally according to other data. Unless otherwise specified, an indicator of some quantity/data may be the quantity/data itself, or an indicator different from the quantity/data itself. A computer program is a sequence of processor instructions carrying out a task. Computer programs described in some embodiments of the present invention may be stand-alone software entities or sub-entities (e.g., subroutines, libraries) of other computer programs. Unless otherwise specified, a computer security program is a computer program that protects equipment and data from unintended or unauthorized access, modification or destruction. Unless otherwise specified, a process is an instance of a computer program, such as an application or a part of an operating system, and is characterized by having at least an execution thread and a virtual memory space assigned to it, wherein a content of the respective virtual memory space includes executable code. Unless otherwise specified, a page represents the smallest unit of virtual memory that can be individually mapped to a physical memory of a host system. Accessing a memory location comprises reading data from the respective memory location or writing data to the respective memory location. The term “logic” encompasses hardware circuitry having a fixed or a reconfigurable functionality (e.g., field-programmable gate array circuits), but does not encompass software emulating such functionality on a general-purpose computer. Unless otherwise specified, a register represents a storage component integrated with or forming part of a processor, and distinct from random-access memory (RAM). Computer readable media encompass non-transitory media such as magnetic, optic, and semiconductor storage media (e.g. hard drives, optical disks, flash memory, DRAM), as well as communication links such as conductive cables and fiber optic links. According to some embodiments, the present invention provides, inter alia, computer systems comprising hardware (e.g. one or more processors) programmed to perform the methods described herein, as well as computer-readable media encoding instructions to perform the methods described herein.

The following description illustrates embodiments of the invention by way of example and not necessarily by way of limitation.

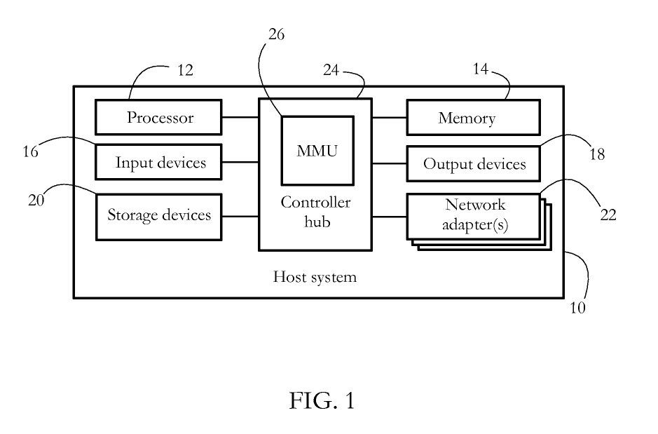

FIG. 1 shows an exemplary hardware configuration of a host system 10 protected from computer security threats according to some embodiments of the present invention. Host system 10 may represent a corporate computing device such as an enterprise server, or an end-user device such as a personal computer, tablet computer, or smartphone. Other exemplary host systems include TVs, game consoles, wearable computing devices, or any other device having a memory and a processor. Host system 10 may be used to execute a set of software applications, such as a browser, a word processing application, and an electronic communication (e.g., email, instant messaging) application, among others. In some embodiments, host system 10 is configured to support hardware virtualization and to expose a set of virtual machines, as shown below.

FIG. 1 illustrates a computer system; the hardware configuration of other host systems, such as smartphones and tablet computers, may differ. System 10 comprises a set of physical devices, including a processor 12, a memory unit 14, a set of input devices 16, a set of output devices 18, a set of storage devices 20, and a set of network adapters 22, all connected by a controller hub 24. In some embodiments, processor 12 comprises a physical device (e.g. multi-core integrated circuit formed on a semiconductor substrate) configured to execute computational and/or logical operations with a set of signals and/or data. In some embodiments, such logical operations are delivered to processor 12 in the form of a sequence of processor instructions (e.g. machine code or other type of software). Memory unit 14 may comprise volatile computer-readable media (e.g. RAM) storing data/signals accessed or generated by processor 12 in the course of carrying out instructions.

Input devices 16 may include computer keyboards, mice, and microphones, among others, including the respective hardware interfaces and/or adapters allowing a user to introduce data and/or instructions into host system 10. Output devices 18 may include display devices such as monitors and speakers, among others, as well as hardware interfaces/adapters such as graphic cards, allowing host system 10 to communicate data to a user. In some embodiments, input devices 16 and output devices 18 may share a common piece of hardware, as in the case of touch-screen devices. Storage devices 20 include computer-readable media enabling the non-volatile storage, reading, and writing of processor instructions and/or data. Exemplary storage devices 20 include magnetic and optical disks and flash memory devices, as well as removable media such as CD and/or DVD disks and drives. The set of network adapters 22 enables host system 10 to connect to a computer network and/or to other devices/computer systems. Controller hub 24 generically represents the plurality of system, peripheral, and/or chipset buses, and/or all other circuitry enabling the communication between processor 12 and devices 14, 16, 18, 20 and 22. For instance, controller hub 24 may include a memory management unit (MMU) 26, an input/output (I/O) controller, and an interrupt controller, among others. In another example, controller hub 24 may comprise a northbridge connecting processor 12 to memory 14 and/or a southbridge connecting processor 12 to devices 16, 18, 20, and 22. In some embodiments, MMU 26 may be integrated, in part or entirely, with processor 12, i.e., MMU 26 may share a common semiconductor substrate with processor 12.

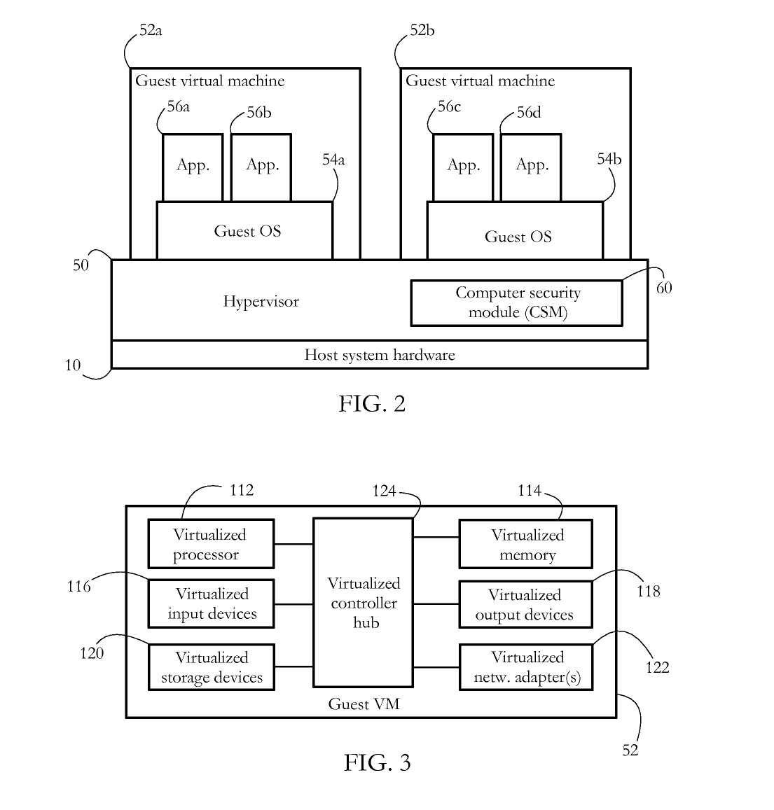

FIG. 2 shows an exemplary configuration according to some embodiments of the present invention, wherein host system 10 uses hardware virtualization technology to operate a set of guest virtual machines 52a-b exposed by a hypervisor 50. Using a hypervisor to manage multiple virtual machines is common in applications such as cloud computing and server consolidation, among others. A virtual machine (VM) is known in the art as an abstraction, e.g., a software emulation, of an actual physical machine/computer system, the VM capable of running an operating system and other applications. In some embodiments, hypervisor 50 includes software configured to create or enable a plurality of virtualized devices, such as a virtual processor and a virtual MMU, and to present such virtualized devices to software in place of the real, physical devices of host system 10. Such operations of hypervisor 50 are commonly known in the art as exposing a virtual machine. In some embodiments, hypervisor 50 allows a multiplexing (sharing) by multiple virtual machines of hardware resources of host system 10. Hypervisor 50 may further manage such multiplexing so that each guest VM 52a-b operates independently and is unaware of other VMs executing concurrently executing on host system 10. Examples of popular hypervisors include the VMware vSphere™ from VMware Inc. and the open-source Xen hypervisor, among others.

Each VM 52a-b may execute a guest operating system (OS) Ma-b, respectively. A set of exemplary applications 56a-d generically represent any software application, such as word processing, image processing, media player, database, calendar, personal contact management, browser, gaming, voice communication, data communication, and computer security applications, among others. Operating systems Ma-b may comprise any widely available operating system such as Microsoft Windows®, MacOS®, Linux®, iOS®, or Android™, among others. Each OS Ma-b provides an interface between applications executing within the respective VM and the virtualized hardware devices of the respective VM. In the following description, software executing on a virtual processor of a virtual machine is said to execute within the respective virtual machine. For instance, in the example of FIG. 2, applications 56a-b are said to execute within guest VM 52a, while applications 56c-d are said to execute within guest VM 52b. In contrast, hypervisor 50 is said to execute outside, or below, guest VMs 52a-b.

FIG. 3 shows an exemplary configuration of a virtual machine 52, as exposed by hypervisor 50. VM 52 may represent any of VMs 52a-b of FIG. 2. VM 52 includes a virtualized processor 112, a virtualized memory unit 114, virtualized input devices 116, virtualized output devices 118, virtualized storage 120, virtualized network adapters 122, and a virtualized controller hub 124. Virtualized processor 112 comprises an emulation of at least some of the functionality of processor 12, and is configured to receive for execution processor instructions forming part of software such as an operating system and other applications. Software using processor 112 for execution is said to execute within virtual machine 52. In some embodiments, virtualized memory unit 114 comprises addressable spaces for storing and retrieving data used by virtualized processor 112. Other virtualized devices (e.g., virtualized input, output, storage, etc.) emulate at least some of the functionality of the respective physical devices of host system 10. Virtualized processor 112 may be configured to interact with such devices as it would with the corresponding physical devices. For instance, software executing within VM 52 may send and/or receive network traffic via virtualized network adapter(s) 122. In some embodiments, hypervisor 50 may expose only a subset of virtualized devices to VM 52 (for instance, only virtualized processor 112, virtualized memory 114, and parts of hub 124). Hypervisor 50 may also give a selected VM direct and exclusive use of some hardware devices of host system 10. In one such example, VM 52a (FIG. 2) may have exclusive use of input devices 16 and output devices 18, but lack a virtualized network adapter. Meanwhile, VM 52b may have direct and exclusive use of network adapter(s) 22. Such configurations may be implemented, for instance, using VT-d® technology from Intel®.

Modern processors implement a hierarchy of processor privilege levels, also known in the art as protection rings. Each such ring or level is characterized by a set of actions and/or processor instructions that software executing within the respective ring is allowed to carry out. Exemplary privilege levels/rings include user mode (ring 3) and kernel mode (ring 0). Some host systems configured to support hardware virtualization may include an additional ring with the highest processor privileges (e.g., ring −1, root mode, or VMXroot on Intel® platforms). In some embodiments, hypervisor 50 takes control of processor 12 at the most privileged level (ring −1), thus creating a hardware virtualization platform exposed as a virtual machine to other software executing on host system 10. An operating system, such as guest OS Ma in FIG. 2, executes within the virtual environment of the respective VM, typically with lesser processor privilege than hypervisor 50 (e.g., in ring 0 or kernel mode). Common user applications, such as 56a-b, typically execute at lesser processor privilege than OS 34a (e.g., in ring 3 or user mode). Some parts of applications 56a-b may execute at kernel privilege level, while some parts of OS 34a may execute in user mode (ring 3). When a software object attempts to execute an action or instruction requiring processor privileges higher than allowed by its assigned protection ring, the attempt typically generates a processor event, such as an exception or a fault, which transfers control of processor 12 to an entity (e.g., event handler of the operating system) executing in a ring with enough privileges to carry out the respective action.

In particular, execution of some processor instructions requires the privilege level of hypervisor 50. In some embodiments, invoking such an instruction from within a virtual machine generates a virtual machine exit event (e.g., VMExit on Intel® platforms). VM exit events suspend the execution of the respective virtual machine and switch processor 12 to executing a handler routine outside the respective VM, at the highest privilege level, e.g., root mode or ring −1. Such handlers are typically part of hypervisor 50.

In some embodiments, VM exits may also be triggered by other events, such as memory access violations. In one such example, when a software object executing within a VM attempts to write data to a memory page marked as non-writable, or to execute code from a memory page marked as non-executable, processor 12 may intercept the attempt, suspend the current execution, and switch to executing hypervisor 50. Such exit mechanisms may allow, for example, a computer security program executing outside the respective VM to protect the virtual machine from security threats, such as malware. Such a program is illustrated as a computer security module (CSM) 60 in FIG. 2. The respective security program may intercept VM exit events occurring in response to certain actions performed by software running inside the VM, actions which may be indicative of a security threat. The security program may then block and/or further analyze such actions, potentially without the knowledge of in-VM software. Such methods may substantially strengthen computer security.

When execution of an instruction within a VM causes a memory access violation, the respective instruction may trigger a VM exit event, even when the respective instruction does not require root privilege. Such situations may arise, for instance, when the instruction instructs processor 12 to read from a memory location marked as non-readable and/or to write to a memory location marked as non-writable. A single instruction may even cause multiple memory access violations (e.g., the MOV instruction of the x86 instruction set). When an instruction causes a memory access violation, conventional systems typically emulate the respective instruction at the level of the hypervisor, before returning execution to the respective VM. Otherwise, returning execution to the respective VM may re-trigger the VM exit event. Providing instruction emulation capabilities to the hypervisor and/or to computer security software executing outside the respective VM may substantially increase the complexity and attack surface of such components. Some embodiments of the present invention provide hardware and methods to reduce the need to emulate instructions outside the respective VM.

Computer security module 60 may be incorporated into hypervisor 50 (for instance as a library), or may be delivered as a computer program distinct and independent from hypervisor 50, but executing at the privilege level of hypervisor 50. CSM 60 may or may not be a process (having a separate scheduled execution thread). In some embodiments, CSM 60 may operate as a collection of unscheduled code objects executing when triggered by certain processor events.

In an alternative embodiment, CSM 60 may execute within a virtual machine, i.e., either within a protected guest VM such as VMs 52a-b, or within a separate, dedicated security VM. In such configurations, CSM 60 may still act as a handler for processor events triggered by a violation of a memory access permission. One exemplary embodiment may use the virtualization exception (#VE) feature of certain Intel® platforms to deliver a special exception (instead of a VM exit) to CSM 60 running inside a guest VM, when a memory access violation occurs. The following description will focus on CSM 60 executing at the level of hypervisor 50, and configured to handle VM exit events. A skilled artisan will appreciate that the described systems and methods can be modified to operate with virtualization exceptions instead of VM exit events.

A single module 60 may be configured to protect multiple guest VMs executing on host system 10. Operations carried out by CSM 60 may include detecting an action performed by a process executing within a guest VM (e.g., calling certain functions of the OS, accessing a registry of the OS, downloading a file from a remote location, writing data to a file, etc.). Other operations of module 60 may comprise determining an addresses of a memory section containing a part of a software object executing within a guest VM, accessing the respective memory section, and analyzing content stored within the respective memory section. Other examples of security operations include intercepting and/or restricting access to such memory sections, e.g., preventing the over-writing of code or data belonging to a protected process, and preventing the execution of code stored in certain memory pages.

To be able to protect a guest VM in a configuration as illustrated in FIG. 2 (i.e., from outside the respective VM), some embodiments of CSM 60 employ address translation data structures and/or address translation mechanisms of processor 12. Virtual machines typically operate with a virtualized physical memory (see, e.g., memory 114 in FIG. 3), also known in the art as guest-physical memory. Virtualized physical memory comprises an abstract representation of the actual physical memory 14, for instance as a contiguous space of addresses, commonly termed guest-physical addresses (GPA). Each such address space is uniquely attached to a guest VM, with parts of said address space mapped to sections of physical memory 14 and/or physical storage devices 20. In systems configured to support virtualization, such mapping is typically achieved using hardware-accelerated, dedicated data structures and mechanisms controlled by processor 12, known as second level address translation (SLAT). Popular SLAT implementations include extended page tables (EPT) on Intel® platforms, and rapid virtualization indexing (RVI)/nested page tables (NPT) on AMD® platforms. In such systems, virtualized physical memory may be partitioned in units known in the art as pages, a page representing the smallest unit of virtualized physical memory individually mapped to physical memory via mechanisms such as EPT/NPT, i.e., mapping between physical and virtualized physical memory is performed with page granularity. All pages typically have a predetermined size, e.g., 4 kilobytes, 2 megabytes, etc. The partitioning of virtualized physical memory into pages is usually configured by hypervisor 50. In some embodiments, hypervisor 50 also configures the SLAT structures, and therefore configures address translation between physical memory 14 and virtualized physical memory. Such address translations are known in the art as guest-physical to host-physical (GPA-to-HPA) translations.

In some embodiments, the operating system executing within a VM sets up a virtual memory space for each process executing within the respective VM, said virtual memory space representing an abstraction of physical memory. Process virtual memory typically comprises a contiguous space of addresses, commonly known in the art as guest-virtual addresses (GVA). In some embodiments, virtual memory spaces are also partitioned into pages, such pages representing the smallest unit of virtual memory individually mapped by the OS to the virtualized physical memory of the respective VM, i.e., virtual to virtualized-physical memory mapping is performed with page granularity. The OS may configure a dedicated data structure, such as a page table, used by the virtualized processor of the respective VM to perform guest virtual to guest physical, or GVA-to-GPA address translations.

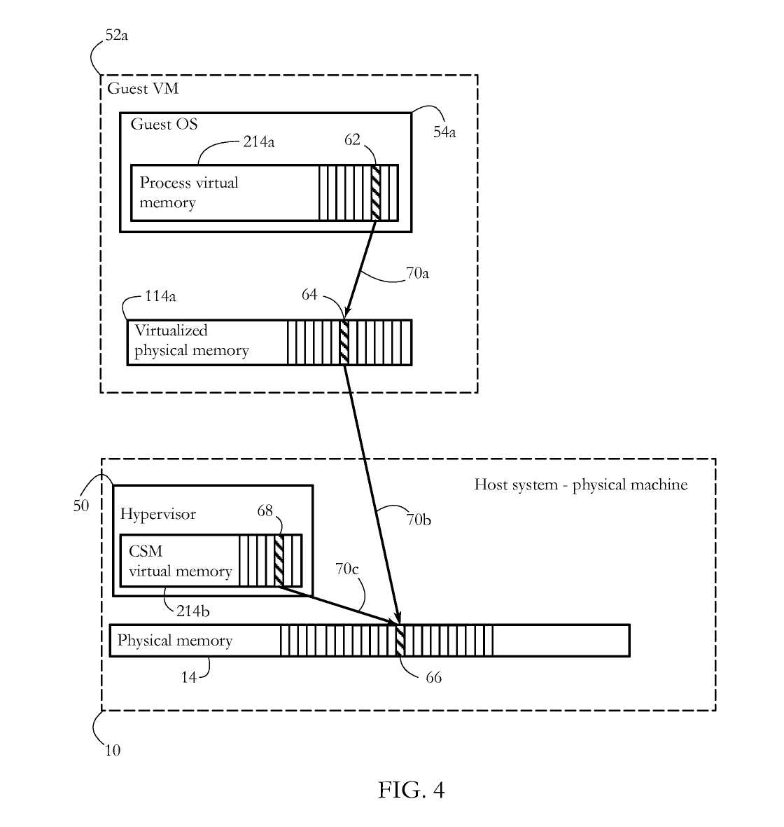

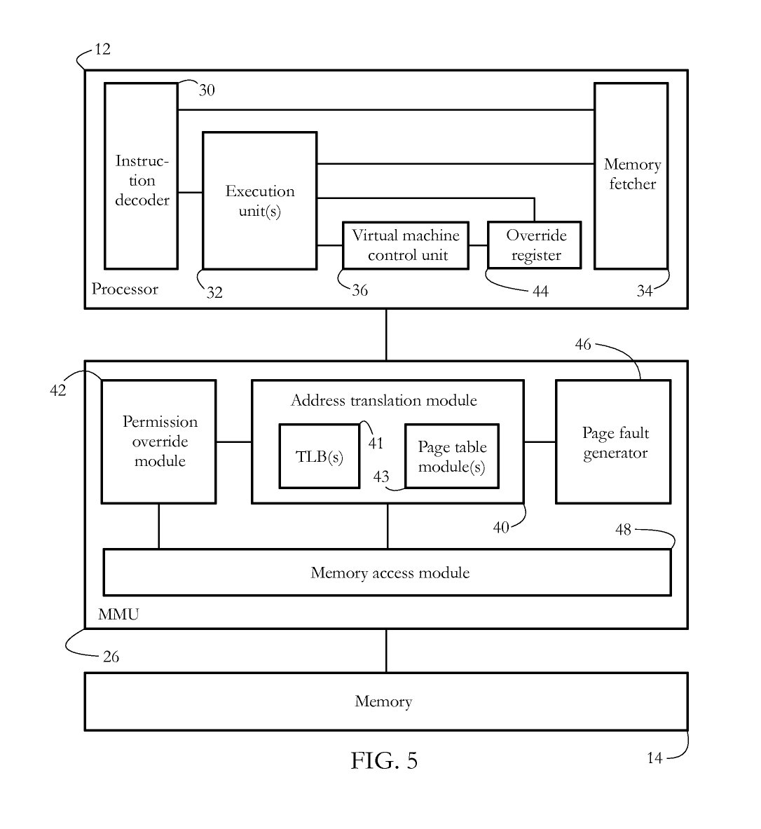

FIG. 4 illustrates an exemplary memory address translation in the embodiment of FIG. 2. Following exposure by hypervisor 50, guest VM 52a sees a virtualized physical memory space 114a as its own physical memory space. A process executing within guest VM 52a is assigned a virtual memory space 214a by guest OS 54a. When the process attempts to access memory at a guest-virtual address 62, GVA 62 is translated by the (virtualized) MMU of guest VM 52a into a guest-physical address 64 within virtualized physical memory space 114a. GVA-to-GPA translation 70a may proceed, for instance, according to page tables configured and controlled by guest OS 34a. GPA 64 is further mapped by MMU 26 to a host-physical address (HPA) 66 within physical memory 14 of host system 10. GPA-to-HPA translation 70b may proceed, for instance, according to SLAT structures configured by hypervisor 50.

In the example of FIG. 4, hypervisor 50 sets up a virtual memory space 214b for computer security module 60. When CSM 60 is integrated within hypervisor 50, for instance as a library, memory space 214b may coincide with the virtual memory space of hypervisor 50. To manage such spaces, hypervisor 50 may configure dedicated data structures and mechanisms (e.g. page tables) used by MMU 26 to perform HVA-to-HPA translations such as translation 70c.

FIG. 5 shows exemplary hardware components of processor 12 and MMU 26 according to some embodiments of the present invention. The illustrated components are meant as generic devices performing the described functionality; structural details may vary substantially among implementations. For instance, each illustrated component may comprise multiple interconnected subsystems, not necessarily in physical proximity to each other. The illustrated components are not exhaustive; processor 12 and MMU 26 may include many other components (e.g., scheduler, register file, interrupt controller, etc.), which were omitted from FIG. 5 for reasons of clarity. In some embodiments, MMU 26 may be integrated, in part or entirely, with processor 12 (e.g., on a shared die).

Modern processors are typically configured for multithreading. In such configurations, physical processor 12 may operate a plurality of cores, each core further comprising multiple logical processors, wherein each logical processor may process an execution thread independently of, and concurrently with, other logical processors. Multiple logical processors may share some hardware resources, for instance, a common MMU. For simplicity, FIG. 5 illustrates a single logical processor, and the associated description refers to the interaction between a single logical processor and a MMU. A skilled artisan will appreciate that the description may be extended to cover each logical processor of a multithreaded configuration.

Processor 12 may include logic/circuitry configured to carry out various stages of a processor pipeline. For instance, an instruction decoder 30 may perform instruction decoding operations, including translating each processor instruction into a set of micro-opcodes. A set of execution units 32 connected to decoder 30 may perform the execution stage of the pipeline. Exemplary execution units 32 include, among others, an arithmetic logic unit (ALU) and a floating-point unit (FPU). A memory fetcher 34 connected to decoder 30 and execution unit(s) 32 includes logic configured to interact with memory 14, e.g., to fetch instructions from memory, to read data from memory, and to commit the result of execution of processor instructions to memory. Such interactions between module 34 and memory unit 14 are intermediated by MMU 26.

Processor 12 may further include a virtual machine control unit 36 configured to manage virtual machine state data. In some embodiments, a virtual machine state object (VMSO) comprises a data structure used internally by processor 12 to represent the current state of each virtualized processor exposed on host system 10. Exemplary VMSOs include the virtual machine control structure (VMCS) on Intel® platforms, and the virtual machine control block (VMCB) on AMD® platforms. VMSOs are typically set up by hypervisor 50. In some embodiments, processor 12 associates a region in memory with each VMSO, so that software may reference a specific VMSO using a memory address or pointer (e.g., VMCS pointer on Intel® platforms).

Each VMSO may comprise a guest state area and a host state area, the guest state area holding the CPU state and/or control registers of the respective guest VM, and the host state area storing the current state and/or control registers of hypervisor 50. In some embodiments, each VMSO further comprises an indicator of a guest context. For instance, the guest state area of the VMSO may include an identifier of a process currently under execution by the respective virtualized processor/VM. One example of such an identifier is stored within the CR3 register of the respective virtual processor, and indicates an address of a page table configured for GVA-to-GPA address translations corresponding to the respective process. The host state area of the VMSO may include a pointer (e.g., an EPT pointer on Intel® platforms) to a SLAT data structure configured for GPA-to-HPA address translations for the respective virtualized processor/guest VM.

In some embodiments, processor 12 may store a part of a VMSO within dedicated internal registers/caches, while other parts of the respective VMSO may reside in memory. At any given time, at most one VMSO (herein termed the current VMSO) may be loaded onto the processor, identifying the virtual processor or VM currently having control of processor 12. In a multithreading embodiment, a distinct VMSO may be loaded onto each distinct logical processor.

When processor 12 switches from executing the respective VM to executing hypervisor 50 (e.g., upon a VM exit), processor 12 may save the state of the respective VM to the guest state area of the current VMSO. When processor 12 switches from executing a first virtualized processor or a first VM to executing a second VM, the VMSO associated to the first VM is unloaded, and the VMSO associated to the second VM is loaded onto the processor, the second VMSO becoming the current VMSO. In some embodiments, such loading/unloading of VMSO data to/from processor 12 is performed by virtual machine control unit 36, e.g., as instructed by hypervisor 50. Unit 36 may further carry out the retrieval and/or saving of VMSO data from/to memory 14.

In some embodiments, processor 12 further comprises an override register 44, configured to store a set of parameters which regulate permission override, as shown in detail below. Such parameters may regulate permission override for the currently executing virtual processor (identified, e.g., by the currently loaded VMSO), or for a particular VM/virtual processor exposed on host system 10 (the targeted virtual processor may be specified, for instance, using a pointer to the respective VMSO). Register 44 may be a dedicated control register of processor 14, or a bank of model-specific registers (MSRs). In another embodiment, register 44 may be part of MMU 26.

In some embodiments, parameters regulating permission override may be stored in a set of dedicated fields of a VMSO of the respective virtual machine, where they can be accessed for reading or writing by software executing, for instance, at the level of hypervisor 50. In such cases, VM control unit 36 may copy the respective parameter values into register 44 when loading the respective VMSO onto the processor, or may access such values from memory on demand, when requested by MMU 26.

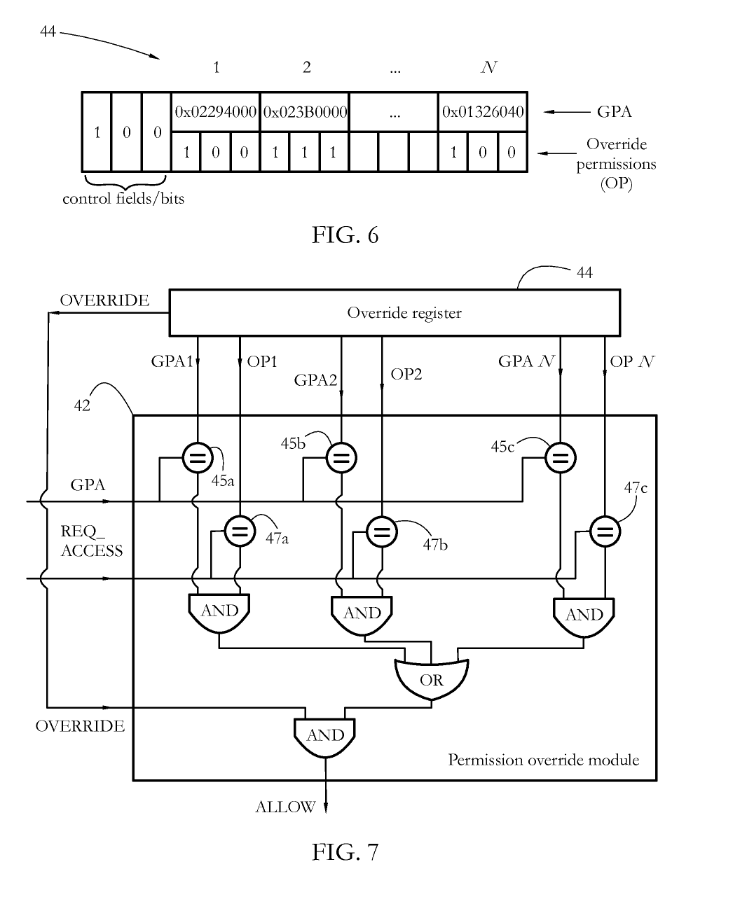

FIG. 6 shows exemplary fields of override register 44, according to some embodiments of the present invention. Register 44 may comprise, among others, a set of control fields, a set of address fields, and a set of permission fields. The provided illustration is meant as a generic example; the order and composition of individual fields may vary from one implementation to another. Also, not all illustrated fields must be part of the same physical register; instead, some fields may reside in various locations within processor 12. In some embodiments, one of the control fields of register 44, herein named override field, indicates whether permission override is currently enabled or not. An exemplary override field comprises a bit, which may take the values 1 (for ON) or 0 (for OFF). The current value(s) of the override field, among others, are used used by MMU 26 to determine whether to allow access to a memory location, wherein the respective access violates current access permissions as indicated, for instance, by a SLAT data structure (EPT on Intel® platforms).

In some embodiments, another control field (e.g., a bit) of register 44, herein named override persistence field, indicates whether permission override is limited to the instruction currently under execution within the respective VM (as indicated, for instance by the current value of the instruction pointer—RIP on Intel® platforms). When the override persistence field is ON (e.g., 1), some embodiments reset the value of the override field in response to detecting that the instruction pointer has changed.

Yet another control field (e.g., a bit) of register 44, herein named interrupt prevention field, indicates whether interrupt injection is suspended during execution of the current instruction within the respective VM. When the interrupt prevention field is ON (e.g., 1), in response to detecting an interrupt, some embodiments delay processing the respective interrupt until the instruction pointer changes indicating that the execution of the current instruction has finished. Servicing interrupt injections in virtual machines is particularly expensive, since interrupts typically produce VM exit events, which in turn require at least switching from the memory context of the respective VM to the memory context of hypervisor 50 and back. VM exit events due to interrupts may further disrupt the operation of computer security module 60, in particular the memory override mechanism as described below. The interrupt prevention field may therefore provide a vehicle for accelerating and stabilizing security operations, among others.

In some embodiments, override register 44 further comprises a set of N address fields (e.g., 8-16 fields), each address field usable to store a memory address targeted for permission override. Addresses stored in such fields may be guest-virtual (GVA) or guest-physical addresses (GPA) expressed in a memory context of the respective virtual machine. For each such target address, register 44 may further include a set of fields (e.g., bits) indicating override permissions (e.g., read, write, and execute) for the respective target address. In some embodiments, each address-permission pair is interpreted by MMU 26 as follows: for the respective target address, perform memory access using the respective override permissions, instead of the permissions currently specified in the SLAT data structure (e.g. EPT) used by the respective virtual processor/VM. Details of how MMU 26 may implement such permission overriding are given below, in relation to FIGS. 7, 8, and 10.

In some embodiments, address-permission pairs may be set with page granularity (e.g., the target address may represent an address of a memory page, and the respective permissions cover all addresses within the respective memory page). In an alternative embodiment, permissions may be defined with granularity finer than a memory page (e.g., for a memory region 32 bits or 128 bits in size, located at or around the indicated address). In one such example, override register 44 may further include, for each address field, a field indicating the size of the protected memory region.

In a simple embodiment, register 44 may include a single address field, storing the address (e.g., GPA) of a current memory access request. This field may be writable by software, for instance by CSM 60 or other software with root privileges. The target address may also be retrieved automatically from an internal register of processor 12, for instance in response to detecting a permission violation at the respective address.

In some embodiments, MMU 26 (FIG. 5) intermediates memory access transactions between processor 12 and memory unit 14. Such transactions include, for instance, fetching processor instructions from memory, reading data from memory, and committing a result of a processor instruction to memory. MMU 26 typically receives a virtual address from processor 12, as well as an indicator of a type of memory access (read/write). In response, MMU 26 looks up a physical address (HPA) corresponding to the virtual address received from processor 12, checks whether the respective type of memory access is allowed according to a set of permissions governing access to the respective HPA, and when yes, performs the requested memory access operation—e.g., reads data from the respective HPA and transfers the data to processor 12, or writes the data received from processor 12 to the respective HPA. In conventional computer systems, memory access permissions are typically read from a SLAT data structure (e.g. EPT on Intel® platforms). In contrast, in some embodiments of the present invention, MMU 26 may read an alternative set of access permissions from override register 44 or from a dedicated field of a VMSO of the respective virtual processor/VM.

In some embodiments, MMU 26 includes an address translation module 40 comprising logic/circuitry dedicated to translating a virtual address received from processor 12 into a corresponding physical address within memory unit 14. Translation module 40 may further comprise a set of translation lookaside buffers (TLB) 41 and a set of page table modules 43. In some embodiments, TLB 41 includes a local cache of address translations recently performed by MMU 26. In some embodiments, upon performing a successful address translation, MMU 26 stores an entry in TLB 41, the entry comprising, among others, an indicator of a virtual address (e.g., GVA) and an indicator of the physical address (e.g., GPA and/or HPA) corresponding to the respective virtual address.

In some embodiments, address translation by module 40 is performed with page granularity, i.e., the address translation first determines the address of a memory page containing the GPA/HPA required for the memory access operation, and subsequently adds an offset to the page address to determine the actual physical address. The actual process of address translation may include determining an address of a virtual page hosting the virtual address to be translated, and determining an offset indicating a location of the virtual address within the respective virtual page. Next, module 40 may search within TLB(s) 41 for an entry corresponding to the respective virtual page. When an entry corresponding to the respective virtual page already exists within the TLB (a situation commonly known in the art as a TLB hit), an address of a physical page corresponding to the respective virtual page is retrieved from the TLB. The actual physical address corresponding to the virtual address to be translated is then obtained by adding the offset to the address of the physical page.

When no entry is found in TLB(s) 41 for the respective virtual page (TLB miss), address translation module 40 may employ page table module(s) 43 to perform a page table walk to determine the address of the physical page. A page table walk typically comprises a set of successive look-ups of addresses within a branched data structure comprising a set of page tables and/or directories, a concept well known in the art. In a hardware virtualization configuration as illustrated in FIG. 2, page table module(s) 43 may first employ a process-specific page table set up by the operating system to carry out a GVA-to-GPA translation (e.g., translation 70a in FIG. 4), and subsequently employ a SLAT structure set up by hypervisor 50 to perform a GPA-to-HPA translation (e.g., translation 70b in FIG. 4).

In some embodiments, each TLB entry is indexed with an indicator of the memory context in which the respective address translation was calculated. Such context indicators may include an identifier of a guest VM and/or an indicator of a process executing within the respective guest VM. Context-specific indexing may accelerate address translation, by allowing some contents of TLB(s) 46 to be preserved and reused after a change of context, most importantly when processor 12 alternates between executing one guest VM and executing hypervisor 50 or another guest VM.

MMU 26 may further include a memory access module 48 and a page fault generator 46, both communicatively coupled to address translation module 40. In some embodiments, memory access module 48 effectively interfaces with physical memory 14 to perform the requested memory access. Module 48 may therefore read from and/or write to a particular memory address, when such access is allowed either by the current permissions indicated in the SLAT data structure of the currently executing VM, or (when permission override is active) by a set of override permissions specified, for instance, in override register 44 (FIG. 6). When the requested access is not allowed either by the current permissions or by the override permissions set for the respective address, page fault generator 46 may generate a processor interrupt event (e.g., a page fault) that suspends execution of the current instruction. In some embodiments, such interrupt events are injected into processor 12, and may trigger a VM exit.

In some embodiments, MMU 26 further comprises a permission override module 42 connected to address translation module 40. Module 42 may receive input (e.g., values of the override field, target addresses, override permissions, etc.) from virtual machine control unit 36 and/or override register 44 of processor 12, and determine according to such input whether to override memory access permissions for the current memory access operation.

FIG. 7 shows an exemplary structure and operation of permission override module 42 according to some embodiments of the present invention. The illustrated module comprises, among others, two sets of comparator devices 45a-c, and 47a-c, respectively. Module 42 receives a memory address, herein denoted GPA, from address translation module 40. GPA represents the memory address to be accessed, and may be a guest-physical address within the virtualized physical address space of the VM currently in execution (e.g., address 64 in FIG. 4). Module 42 further receives an indicator of a requested access type (e.g., read, write), herein denoted REQ ACCESS, from processor 12.

Exemplary module 42 outputs an indicator/signal, herein denoted ALLOW. In some embodiments, a high value (e.g., 1) of ALLOW indicates that the current memory access is allowed, while a low value (e.g., 0), indicates that the current memory access is not allowed, either by the current access permissions, or by the override permissions. Module 42 further receives a signal, herein denoted OVERRIDE, from override register 44. In some embodiments, OVERRIDE indicates a current value of the override field of register 44, i.e., indicates whether memory access override is currently active (ON). The OVERRIDE signal may act as an activation signal for override module 42, i.e., module 42 is enabled and therefore produces an output only when OVERRIDE is high/ON.

Module 42 further receives a set of addresses (denoted GPA₁, . . . GPA_{N}) and a set of override permission indicators (denoted OP₁, . . . , OP_{N}) from override register 44 and/or from VM control unit 36. In the given example, each GPAᵢ represents an address (e.g., guest-physical), expressed in the memory context of the currently executing VM, for which permission override is active/ON, while OPᵢ indicate override permissions defined for address GPAᵢ. Such values may be written by software (e.g. CSM 60) into override register 44 and/or into a dedicated field of the VMSO of the currently executing VM.

In the illustrated embodiment, each comparator 45a-c compares GPA with a target GPAᵢ, while each comparator 47a-c compares REQ ACCESS with OPᵢ. Such comparisons may be carried out in parallel for all address entries of register 44. When at least one target address GPAᵢ matches GPA, and at the same time the required access type (read, write) matches the override permissions OPᵢ defined for the respective target address, the illustrated OR gate outputs a high value/signal (e.g., 1). An AND gate combines the output of the OR gate with the OVERRIDE signal, to produce a high ALLOW value/signal when override is active, at least one target address matches GPA, and override permissions allow the requested access. When GPA does not match any target GPAᵢ or when the override permissions OPᵢ set for the matching GPAᵢ do not allow the type of memory access indicated by REQ ACCESS, module 42 outputs a low value of ALLOW (e.g., 0).

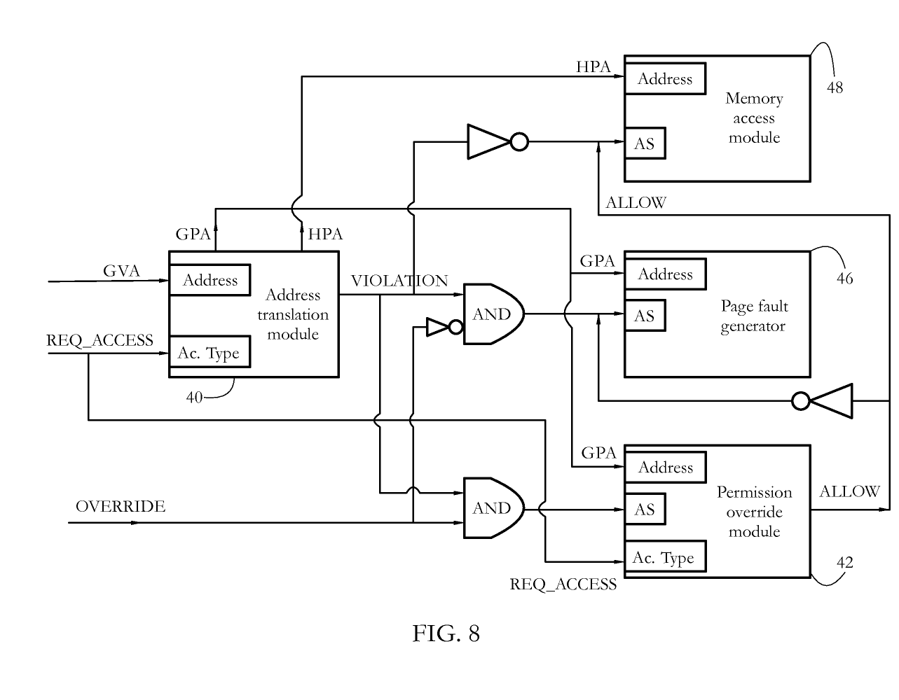

FIG. 8 shows an exemplary manner in which components of MMU 26 collaborate to perform permission overriding according to some embodiments of the present invention. In the illustrated example, each of memory access module 48, page fault generator 46, and permission override module 42 is configured to receive an activation signal, herein denoted AS. In some embodiments, components 42, 46, and 48 only produce an output when AS is high (e.g., 1). Address translation module 40 may be configured to receive two inputs: an address (typically a guest-virtual address) and an indicator of an access type (e.g., read, write). Components 42, 46, and 48 may be configured to receive an address as input. Permission override module 42 may be further configured to receive an indicator of access type (see also description above, in relation to FIG. 7).

In the example of FIG. 8, module 40 receives a request from processor 12 to access memory address GVA, in a manner indicated by REQ ACCESS (e.g., read or write). The request is generated in response to processor 12 attempting to execute an instruction within a virtual machine, such as VMs 52a-b in FIG. 2. Module 40 attempts to translate GVA into a GPA and a HPA, using page tables set up by the operating system of the respective VM and/or by hypervisor 50. In performing address translation, module 40 may further check a SLAT structure (e.g., an EPT) of the respective VM to determine whether the requested access is allowed according to current access permissions. When the requested access is allowed, memory access module 48 activates (high AS), receives the HPA produced as a result of address translation, and performs the requested access to memory 14.

When the requested access is not allowed, module 40 may output a VIOLATION signal to other components of MMU 26. MMU 26 may further receive an OVERRIDE signal/input from override register 44 and/or VM control module 36 of processor 12. In some embodiments, a high value of OVERRIDE (e.g., 1) indicates that the override field of register 44 is set to a value indicating that permission override is currently active. A low value of OVERRIDE (e.g., 0) may indicate that permission override is currently switched off. A comparison between the VIOLATION signal and the OVERRIDE signal is input as activation signal to page fault generator 46. When the requested memory access is not allowed and OVERRIDE is low, page fault generator 46 activates and triggers a processor event (e.g., page fault). The event may further trigger a VM exit suspending the execution of the current VM.

A comparison between the VIOLATION and OVERRIDE signals is input as activation signal to permission override module 42. When both VIOLATION and OVERRIDE are high (e.g., 1), permission override module 42 is activated. In some embodiments, module 42 compares the GPA received from address translation module 40 with a list of target GPAs received from override register 44 and/or from VM control module 36, the target GPAs indicating addresses selected for permission override. Module 42 further compares override permissions received from register 44 and/or module 36 with REQ ACCESS. When conditions for override are met (see description above, in relation to FIG. 7), module 42 outputs an ALLOW signal, which in turns activates memory access module 40, in spite of the high VIOLATION signal. Module 40 therefore performs the requested memory access.

When conditions for override are not met, for instance when GPA is not among the list of addresses targeted for permission override, or when override permissions are not compatible with the requested access type, module 42 outputs a low ALLOW signal (e.g., 0), which in turn activates page fault generator 46, triggering an interrupt within processor 12.

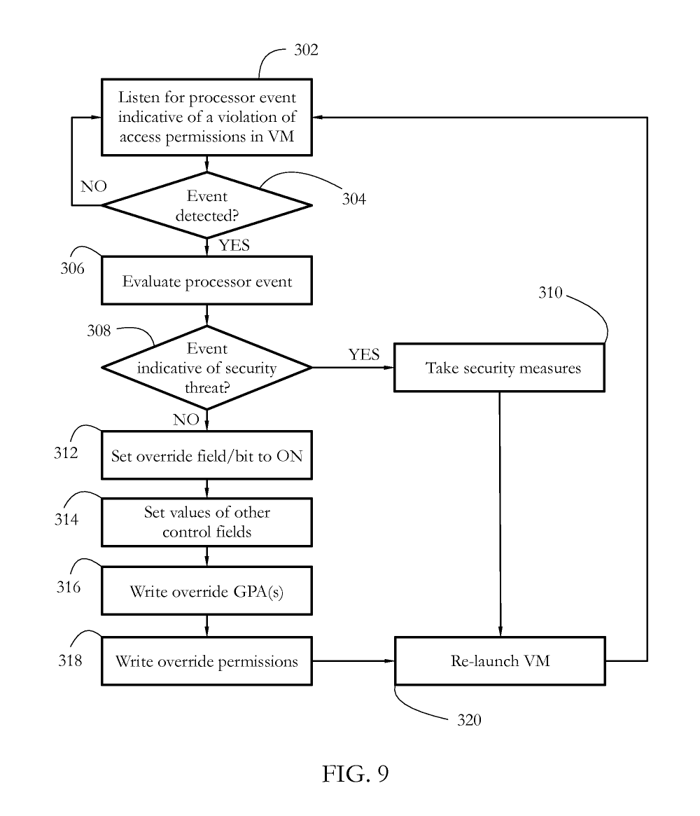

FIG. 9 shows an exemplary sequence of steps performed by some embodiments of computer security module 60 (FIG. 2) to protect host system 10 from computer security threats such as malware. FIG. 9 thus illustrates how hardware components described above, in relation to FIGS. 5-8, may be used in security applications. In some embodiments, CSM 60 executes outside the protected VM(s), at the level of hypervisor 60. CSM 60 may be configured to act as an event handler for VM exit events, i.e., when an instruction executing within a virtual machine causes a VM exit event, processor 12 may automatically switch to executing CSM 60. In a sequence of steps 302-304, CSM 60 may detect a violation of a memory access permission within a VM, for instance by intercepting a VM exit event and determining according to parameters of the event that the event was caused by a violation of memory access permissions.

In a step 306, CSM 60 may evaluate the processor event to determine whether it indicates a security threat, e.g., malware. Execution of step 306 may employ any anti-malware and/or security heuristic known in the art. Step 306 may include, for instance, determining the address that triggered the violation, identifying a software object (e.g., process) attempting the respective memory access, and identifying a software object that owns the content stored at the respective address. CSM 60 may thus establish, for instance, that a process is attempting to write to the memory space of another process, an operation known as data or code injection/alteration and which is often performed by malware. When the processor event is indicative of a computer security threat, in a step 310, CSM 60 may take security measures, such as blocking the respective memory access, preventing a further execution of the respective software object, notifying the user or a system administrator, etc.

When the processor event is not indicative of a security threat, some embodiments enable a permission override for the address that triggered the violation, so that the respective instruction can be re-executed within the respective VM without causing another access violation. In a step 312, CSM 60 may set the override field to a value indicating activation of permission override. In an embodiment wherein override control fields are stored in a processor register (e.g., override register 44, see FIG. 6), CSM 60 may use a processor instruction such as MOV or WRMSR on x86 platforms, to set the override field to a value that indicates that permission override is active. In an alternative embodiment wherein override control fields are stored in dedicated fields of a VMSO structure used to manage operation of the respective VM, CSM 60 may set the value of the override field using an instruction such as VMWRITE on Intel® platforms that support virtualization.

In a step 314, CSM 60 may set other control fields regulating permission override. Such fields may include, among others, an override persistence field and an interrupt prevention field, as described above in relation to FIG. 6. The override persistence field may indicate whether permission override should expire once the instruction currently executed by the respective virtual processor finishes execution. In some security applications, it may be useful to reset the permission override after each processor instruction which violates access permissions. In other applications, the override may be maintained on the same virtual processor over multiple processor instructions. In one such example, applicable to debugging or code monitoring, the override persistence field may be set so that permission override is maintained for a predetermined number of processor instructions. In another example applicable to computer security, permission override may be maintained indefinitely for a subset of addresses or memory pages where memory access is deemed benign or legitimate. In such configurations, once access to a memory address or page is analyzed and proven to be legitimate, any subsequent memory access to the respective memory address or page will not trigger a violation, thus substantially accelerating execution.

Setting the interrupt prevention field may indicate to processor 12 whether to accept interrupts during execution of the current instruction within the respective VM. Delaying the handling of interrupts until the respective instruction finishes executing may substantially accelerate some applications, while also improving stability.

In a step 316, CSM 60 may write an address targeted for permission override to override register 44 or to a dedicated field of a VMSO used for managing the operation of the respective VM. In some embodiments, the address is a guest physical address (GPA), and may represent the address which triggered the permission violation. In some embodiments, step 316 may comprise writing multiple GPAs. For instance, an instruction moving data from a source address to a destination address may cause multiple access violations, when the source address is read-protected, and the destination address is write-protected. In some embodiments, when the respective instruction is considered legitimate, step 316 may write both addresses to register 44, so as to enable permission override for both.

In a step 318, CSM 60 may write override permissions for the respective target GPAs to override register 44 and/or to a dedicated field of the VMSO. Such override permissions may indicate a preferred manner of accessing each address, manner which replaces current access permissions specified, for instance, in the SLAT structure used for the respective VM. For instance, when the current instruction causes a violation for attempting to read from an address marked as non-writable, the override permission associated with the respective address may indicate that the respective address is writable, etc. As a result of step 318, a subsequent attempt to access the respective memory address will be evaluated according to the indicated override permissions. In a step 320, CSM 60 may instruct processor 12 to re-launch the respective VM.

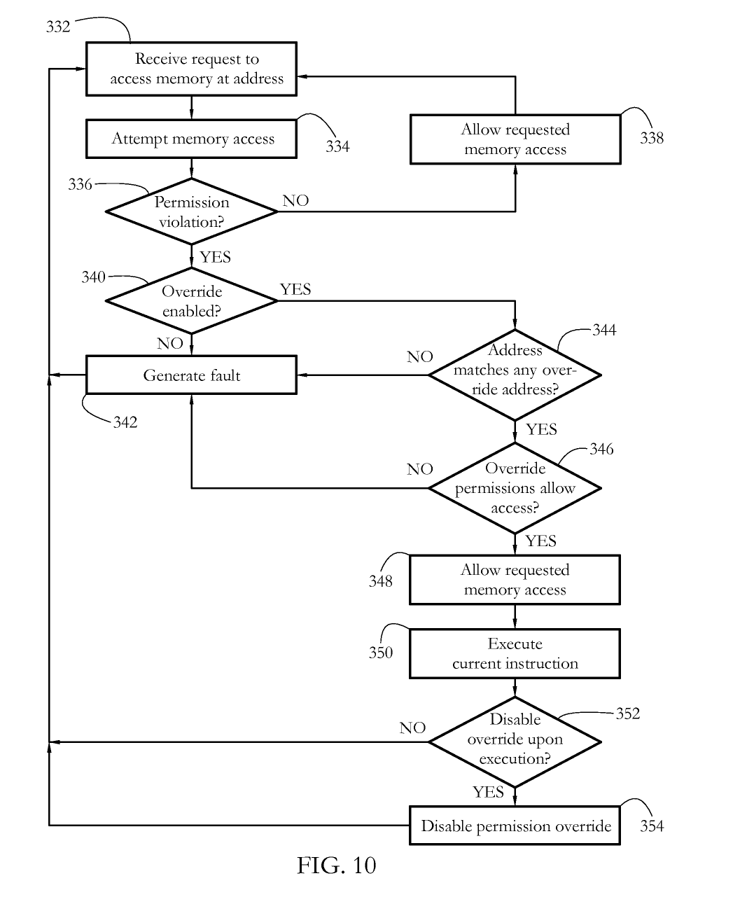

FIG. 10 shows an exemplary sequence of steps performed by processor 12 and/or MMU 26 to perform a permission override according to some embodiments of the present invention. FIG. 10 further illustrates the operation of hardware components shown in FIGS. 5-8. In a step 332, MMU 26 receives from processor 12 a request to access memory at a location indicated by an address (e.g., guest-virtual address GVA), the request received as part of processor 12 executing an instruction within a virtual machine. In a step 334, MMU 26 may translate the address into a GPA and/or a HPA, and attempt to access the respective memory location. The attempt comprises checking whether current access permissions set for the memory page containing the respective location allow the requested access. When yes, in a step 338, MMU 26 performs the requested access (read from or write to the indicated location).

When access permissions do not allow the requested access, in a step 340, components of MMU 26, for instance permission override module 42, may determine whether permission override is enabled. Step 340 may comprise looking up a value of the override field in override register 44 or in the VMSO of the currently executing VM. When override is not enabled, a step 342 generates a fault.

When override is enabled as indicated by the value of the override field, in a step 344, module 42 may check whether the memory address of the current memory access request matches any target address selected for permission override. Step 344 may comprise receiving the GPA of the current access request from address translation module 40, and looking up target GPAs in override register 44 or in the VMSO of the respective VM. When no match is found, MMU generates a fault (step 342).

When the current GPA matches at least one GPA selected for permission override, in a step 346, module 42 may determine whether override permissions specified for the matching GPA in override register 44 and/or the VMSO of the respective VM allow the requested access. In an embodiment as illustrated in FIG. 7, logic operations corresponding to steps 340, 344, and 346 may be performed in parallel.

When override permissions no not allow the requested access, a fault is generated (step 342). When override permissions allow the requested access, a step 348 actually carries out the requested memory access. In situations where executing one instruction requires multiple memory accesses, the sequence of steps 332-348 may be repeated for each such memory access.

In a step 350, processor 12 may finish executing the current instruction. In a step 352, a component of processor 12 may check whether permission override should extend to the next processor instruction. In some embodiments, the decision whether to maintain the override is taken according to a current value of the override persistence field of register 44 or of the VMSO of the respective VM. When override is not persistent, in a step 354, the override field is reset to a value (e.g., 0) indicating that permission override is disabled.

The exemplary systems and methods described above allow a MMU of a host system to selectively override access permissions regulating how a virtual machine accesses the memory of a host system. Such permission overrides may substantially accelerate the operation of hardware virtualization platforms, in application such as computer security, code monitoring, debugging, etc.

In some embodiments, a computer security program executes below all guest VMs exposed by the host system, and is configured to protect guest VMs from computer security threats, such as malware and spyware. Protection typically includes analyzing a content of memory accessed by software executing within a guest VM, and controlling access to memory by such software. In conventional computer systems supporting hardware virtualization, access to memory is regulated via a set of access permissions indicating, for instance, whether a certain memory region may be read from or written to. Access permissions are typically set with page granularity, and may be set using dedicated fields of a second level address translation data structure (such as EPT on Intel® platforms) used to carry out memory address translations for each VM.

In conventional computer systems, a violation of a memory access permission, such as an attempt by a software object executing within a VM to write to a memory region marked as non-writable, typically generates a processor interrupt event. Such events may cause the processor to suspend execution of the respective VM, and to switch to executing a hypervisor underlying the respective VM.

The operation of the respective VM is eventually resumed, but as long as the access permissions remain unchanged, any attempt to re-execute the instruction that caused the memory violation in the first place will typically re-trigger the interrupt, potentially generating an infinite loop. There are currently several methods known in the art, which address this problem. In one conventional approach, the instruction that triggers the memory access violation is emulated at hypervisor level, before re-launching the respective VM. This approach requires implementing instruction emulation functionality into the hypervisor, which may substantially increase the complexity and attack surface of the hypervisor, which is a critical component for the security of the host system. In addition, instruction emulation itself may create a security breach, since emulated instructions are typically executed while ensuring that such emulation does not generate memory access violations. Therefore, a carefully crafted malicious instruction may succeed in producing changes in the host system via emulation, therefore evading detection.

Another approach to avoiding the potential infinite loop created by memory access violations in virtual machines comprises switching the virtual processor of the respective VM to a single step mode (or debug mode), wherein the virtual processor executes only one instruction at a time. The hypervisor may then modify the permissions to allow the respective memory access and re-launch the respective VM. After the current instruction finishes executing and the respective VM is suspended due to single-stepping, the hypervisor may re-instate the original permissions and re-launch the respective VM. This approach requires at least two VM exits for each access violation event, as is therefore relatively expensive in terms of computation. In addition, the single-stepping approach may require that other virtual processors/VMs be halted for the duration of the procedure, in order to prevent them from accessing the respective memory region while the access permissions are temporarily modified.

In contrast, some embodiments of the present invention allow processing violations of memory access permissions without emulation and single-stepping. Some embodiments employ a dedicated data structure, such as a register of the processor or a dedicated part of a data object used for managing the operation of the respective virtual machine (e.g. VMCS on Intel® platforms, VMCB on AMD® platforms), to store a set of addresses targeted for permission override. For each such address, some embodiments may also store a set of override permissions. The data structures are made accessible to software, for instance to the hypervisor or to computer security software executing at the level of the hypervisor. Some embodiments further describe processor logic configured, in response to detecting a violation of access permissions at an address, to determine whether override permissions are defined for the respective address, and whether the override permissions allow the respective access, all without exiting the respective VM. When access is allowed according to override permissions defined for the respective address, processor logic may allow the requested memory access to proceed.

Therefore, some embodiments of the present invention allow an instruction that generates a memory access violation to execute natively (i.e., within the respective VM). By avoiding computation associated with VM exits, such an approach may be substantially faster that conventional methods comprising emulation and/or single-stepping. Some embodiments of the present invention further remove some of the security vulnerabilities and stability issues currently associated with conventional methods.

In an exemplary security application according to some embodiments of the present invention, a security module executing at the level of the hypervisor intercepts a VM exit event caused by a violation of a memory access permission within the respective VM. When the respective event is considered benign, the security module may select the respective memory address for override, and may indicate override permissions for the respective address. Upon returning execution to the respective VM, the respective instruction will be re-executed natively, without re-triggering the VM exit.

It will be clear to a skilled artisan that the above embodiments may be altered in many ways without departing from the scope of the invention. Accordingly, the scope of the invention should be determined by the following claims and their legal equivalents.

What is claimed is:

1. A host system comprising a hardware processor configured to execute a virtual machine and a computer security program, wherein the hardware processor comprises a register including an override field, wherein the computer security program is configured to modify a content of the override field, and wherein the hardware processor is further configured to:
determine whether accessing a memory location causes a violation of an access permission, wherein accessing the memory location occurs as part of executing an instruction within the virtual machine; and
in response, when accessing the memory location causes the violation:
determine according to the content of the override field whether permission override is enabled, and
in response, when permission override is enabled, access the memory location.

2. The host system of claim 1, wherein the access permission is stored in a second level address translation (SLAT) data structure used by the processor to perform address translations for the virtual machine.

3. The host system of claim 1, wherein the register further includes an address field and wherein the hardware processor is further configured to, when accessing the memory location causes the violation and when permission override is enabled:
determine whether a content of the address field is indicative of the memory location, and
in response, access the memory location when the content of the address field is indicative of the memory location.

4. The host system of claim 3, wherein the content of the address field comprises a guest-physical address.

5. The host system of claim 3, wherein the computer security program is further configured to modify the content of the address field.

6. The host system of claim 1, wherein the register further includes an override permission field configured to store a second access permission, and wherein the hardware processor is further configured to, when accessing the memory location causes the violation and when permission override is enabled:
determine whether the second access permission allows accessing the memory location, and
in response, access the memory location when the second access permission allows accessing the memory location.

7. The host system of claim 6, wherein the computer security program is further configured to modify the second access permission.

8. The host system of claim 1, wherein the register further includes an override persistence field, and wherein the hardware processor is configured to, in response to accessing the memory location:
determine according to a content of the override persistence field whether permission override is persistent, and
in response, when permission override is not persistent, modify the content of the override field to indicate that permission override is disabled.

9. The host system of claim 1, wherein the register further includes an interrupt prevention field, and wherein the hardware processor is configured to, when accessing the memory location causes the violation and when permission override is enabled:
determine according to a content of the interrupt prevention field whether interrupt prevention is enabled, and
in response, when interrupt prevention is enabled, delay handling of hardware interrupts until the instruction finishes executing.

10. The host system of claim 1, wherein the computer security program executes outside the virtual machine.

11. The host system of claim 1, wherein the computer security program executes within the virtual machine and wherein the hardware processor is further configured to deliver virtualization exceptions to the computer security program.

12. The host system of claim 1, wherein the override field is directly writable by the computer security program.

13. The host system of claim 1, wherein modifying the content of the override field comprises writing the content into a data structure used by a hypervisor exposing the virtual machine to manage operation of the virtual machine.

14. The host system of claim 13, wherein the data structure is a virtual machine control structure (VMCS).

15. A method of protecting a host system from computer security threats, the host system comprising a hardware processor, the hardware processor further comprising a register that includes an override field, the method comprising:
employing a computer security program to modify a content of the override field;
employing the hardware processor to determine whether accessing a memory location causes a violation of an access permission, wherein accessing the memory location occurs as part of executing an instruction within a virtual machine exposed on the host system; and
in response, when accessing the memory location causes the violation:
employing the hardware processor to determine according to the content of the override field whether permission override is enabled, and
in response, when permission override is enabled, employing the hardware processor to access the memory location.

16. The method claim 15, wherein the access permission is stored in a second level address translation (SLAT) data structure used by the processor to perform address translations for the virtual machine.

17. The method of claim 15, wherein the register further includes an address field, the method further comprising, when accessing the memory location causes the violation and when permission override is enabled:
employing the hardware processor to determine whether a content of the address field is indicative of the memory location, and
in response, accessing the memory location when the content of the address field is indicative of the memory location.

18. The method of claim 17, wherein the content of the address field comprises a guest-physical address.

19. The method of claim 17, further comprising employing the computer security program to modify the content of the address field.

20. The method of claim 15, wherein the register further includes an override permission field configured to store a second access permission, the method further comprising, when accessing the memory location causes the violation and when permission override is enabled:
employing the hardware processor to determine whether the second access permission allows accessing the memory location, and
in response, accessing the memory location when the second access permission allows accessing the memory location.

21. The method of claim 20, further comprising employing the computer security program to modify the second access permission.

22. The method of claim 15, wherein the register further includes an override persistence field, the method further comprising, in response to accessing the memory location:
employing the hardware processor to determine according to a content of the override persistence field whether permission override is persistent, and
in response, when permission override is not persistent, employing the hardware processor to modify the content of the override field to indicate that permission override is disabled.

23. The method of claim 15, wherein the register further includes an interrupt prevention field, the method further comprising, when accessing the memory location causes the violation and when permission override is enabled:
employing the hardware processor to determine according to a content of the interrupt prevention field whether interrupt prevention is enabled, and
in response, when interrupt prevention is enabled, delay handling of hardware interrupts by the hardware processor until the instruction finishes executing.

24. The method of claim 15, wherein the computer security program executes outside the virtual machine.

25. The method of claim 15, wherein the computer security program executes within the virtual machine and wherein the hardware processor is further configured to deliver virtualization exceptions to the computer security program.

26. The method of claim 15, wherein the override field is directly writable by the computer security program.

27. The method of claim 15, wherein modifying the content of the override field comprises writing the content into a data structure used by a hypervisor exposing the virtual machine to manage operation of the virtual machine.

28. The method claim 27, wherein the data structure is a virtual machine control structure (VMCS).

29. A non-transitory computer-readable medium storing instructions which, when executed by a hardware processor of a host system exposing a virtual machine, cause the host system to form a computer security program, wherein the hardware processor comprises a register that includes an override field, wherein the computer security program is configured to modify a content of the override field, and wherein the hardware processor is further configured to:
determine whether accessing a memory location causes a violation of an access permission, wherein accessing the memory location occurs as part of executing a guest instruction within the virtual machine; and
in response, when accessing the memory location causes the violation:
determine according to a the content of the override field whether permission override is enabled, and
in response, when permission override is enabled, access the memory location.

30. The computer-readable medium of claim 29, wherein modifying the content of the override field comprises:
intercepting a processor event comprising suspending execution of the virtual machine in response to a second violation of the access permission;
determining whether the event is indicative of a computer security threat; and
in response, when the event is not indicative of the security threat:
setting the content of the override field to indicate that permission override is enabled, and
instructing the hardware processor to re-launch the virtual machine.
